(19) United States
(12) Patent Application Publication
(10) Pub. No.: US 2008/0100700 A1
(43) Pub. Date: May 1, 2008

(54) ELECTRONIC ENDOSCOPE

(75) Inventor: Katsuya Tannai, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/877,782

(22) Filed: Oct. 24, 2007

(30) Foreign Application Priority Data
Oct. 27, 2006 (JP) 2006-292246

(51) Int. Cl. H04N 7/18

(52) U.S. Cl. 348/65

(57) ABSTRACT

An electronic endoscope has a first signal-reading processor that successively reads image-pixel signals from an image sensor at regular intervals, and a moving-image signal processor that generates video signals on the basis of the image-pixel signals read according to the pixel mixing method. Further, the electronic endoscope has a second signal-reading processor, a still-image signal processor, and a signal output processor. The second signal-reading processor reads one frame's worth of image-pixel signals, obtained in a single exposure, from the image sensor. The still image signal processor generates still image signals on the basis of the one frame's worth of image-pixel signals obtained in the single exposure. The signal output processor outputs the one frame's worth of image-pixel signals obtained in the single exposure to peripheral equipment while the still image signals are generated.

### BACKGROUND OF THE INVENTION

1. Field of the Invention

The present invention relates to an electronic endoscope that is capable of displaying a moving image and a still image. In particular, it relates to a signal process for displaying and recording a still image.

2. Description of the Related Art

In an electronic endoscope, a moving image is displayed on a monitor by using an interline-transfer type CCD, and further, a still image can be displayed and recorded by the interline-transfer CCD. In normal observation mode, during each field interval, alternately odd-field image-pixel signals or even-field image-pixel signals are read from the CCD. On the other hand, when displaying and/or recording a still image (i.e., when carrying out a so-called “freezing operation”), one whole frame's worth of image-pixel signals obtained from a single exposure are generated and read from the CCD. Namely, odd-line image-pixel signals and even-line image-pixel signals are read from the CCD, in order, within a one-frame reading interval. Consequently, a high-quality still color image without blur is obtained.

Peripheral equipment, such as a computer or recorder, can be connected to a video-processor, and still image data can be transmitted to the peripheral equipment. However, when carrying out the recording process is performed together with the displaying process, it takes a long time to return from the freezing operation to the normal observation mode.

### SUMMARY OF THE INVENTION

An object of the present invention is to provide an electronic endoscope or apparatus/method for processing image signals that is capable of displaying a color still image and transmitting still image data instantly.

An electronic endoscope according to the present invention has a first signal-reading processor that successively reads image-pixel signals from an image sensor at regular intervals; and a moving-image signal processor that generates video signals on the basis of the image-pixel signals read from the image sensor. The image sensor is provided in a video-scope, and a subject image is formed on the image sensor by light passing through a color filter, so that image-pixel signals are generated in the image sensor. For example, color elements of the color filter may be arrayed in a checkered pattern, and the image sensor may be an inter-line transfer image sensor. In this case, the first signal-reading processor may read even-field image-pixel signals and odd-field image-pixel signals alternately while mixing neighboring pixels.

Further, the electronic endoscope has a second signal-reading processor, a still-image signal processor, and a signal output processor. The second signal-reading processor reads one frame's worth of image-pixel signals, obtained in a single exposure, from the image sensor. The still-image signal processor generates still image signals on the basis of the one frame's worth of image-pixel signals obtained by the single exposure. The signal output processor is capable of outputting the video signals and the still image signals to peripheral equipment. For example, an image switch member that is operated to display and/or record a still image is provided. The second signal-reading processor is performed when the image switch member is operated. For example, the second-signal reading processor reads odd-line image-pixel signals and even-line image-pixel signals, obtained in a single exposure, in order. In this case, the still-image signal processor may have a composite processor that interpolates color information on the basis of neighboring odd-line and even-line image-pixel signals.

In the present invention, the signal output processor outputs the image-pixel signals obtained in the single one-time exposure to the peripheral equipment while the still image signals are generated. In other words, the image-pixel signals are output to the peripheral equipment as still image data before the still image signals for displaying a still image are output. Consequently, the displaying process and the recording process are carried out rapidly, and a moving image can be instantly displayed after the still image is displayed and recorded.

For example, the still-image signal processor has a first signal processor and a second signal processor. The first signal processor connects with the signal output processor, and receives one frame of image-pixel signals. The second signal processor connects with the first signal processor, and generates the still image signals on the basis of one frame of image-pixel signals fed from the first signal processor.

On the other hand, the signal output processor has a switch that selectively connects the still-image signal processor to either a monitor or a recording apparatus capable of recording a still image. The switch connects the still image signal processor with the recording apparatus.

An apparatus for processing image signals according to another aspect of the present invention has a signal reading processor that reads one frame's worth of image-pixel signals, obtained in a single exposure, from an image sensor with a color filter that is provided in a video-scope; a still-image signal processor that generates still image signals on the basis of the one frame's worth of image-pixel signals obtained in a single exposure; and a signal output processor that is capable of outputting the still image signals to peripheral equipment. Then, the signal output processor outputs the one frame's worth of image-pixel signals obtained in the single exposure to the peripheral equipment while the still image signals are generated.

A method for processing image signals according to another aspect of the present invention has: a) reading one frame's worth of image-pixel signals, obtained in a single exposure, from an image sensor with a color filter that is provided in a video-scope; b) generating still image signals on the basis of the one frame's worth of image-pixel signals obtained in the single exposure; and c) outputting the image-pixel signals obtained in the single exposure to peripheral equipment while the still image signals are generated.

### BRIEF DESCRIPTION OF THE DRAWINGS

The present invention will be better understood from the description of the preferred embodiments of the invention set forth below together with the accompanying drawings, in which:

FIG. 1 is a block diagram of an electronic endoscope according to the present embodiment;

FIG. 2 is block diagram of a latter signal processing circuit and an I/F circuit; and

FIG. 3 is a timing chart of the freeze operation.

### DESCRIPTION OF THE PREFERRED EMBODIMENTS

Hereinafter, the preferred embodiment of the present invention is described with reference to the attached drawings.

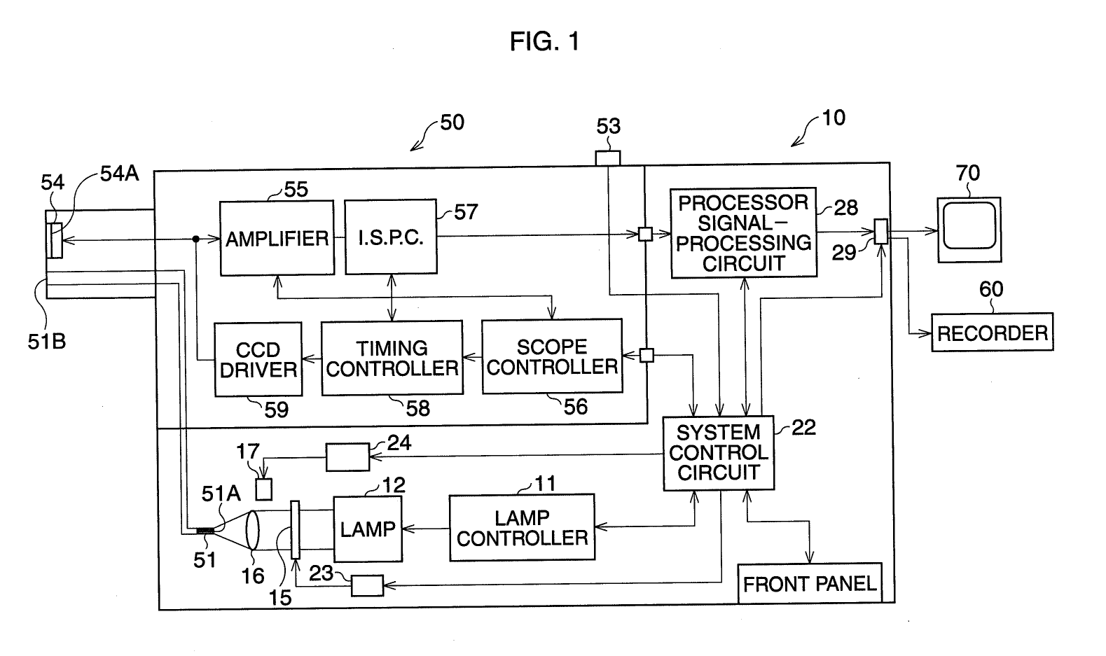

FIG. 1 is a block diagram of an electronic endoscope according to the present embodiment.

An electronic endoscope is equipped with a video-scope 50 having a CCD 54 and a video-processor 10. The video-scope 50 is removably connected to the video-processor 10, and a recorder 60 and a monitor 70 are connected to the video-processor 10.

When a lamp switch (not shown) is turned on, electric power is supplied from a lamp controller 11 to a lamp 12, so that the lamp 12 emits white light. The emitted light passes through a rotary shutter 15 and a collecting lens 16, and enters into an incident surface 51A of a light guide 51. The light guide 51, composed of a fiber-optic bundle, directs the light to the tip portion of the video-scope 50. The light, passes through the light guide 51, exits from the tip of light guide 51, and exits from the tip of the video-scope 50 via a diffusion lens (not shown), so that an observed portion is illuminated.

Light reflected off the observed portion passes an objective lens (not shown) and reaches the CCD 54, so that an object image is formed on a photo-sensor area of the CCD 54. On the photo-sensor area of the CCD 54, a complementary color filter 54A, checkered by four color elements, Yellow (Y), Magenta (Mg), Cyan (Cy), and Green (G), is arranged such that each area of the four color elements is opposite a pixel.

In the CCD 54, based on light passing through the complementary color filter, image-pixel signals are generated by the photoelectric effect. A CCD driver 59 outputs clock pulse signals to the CCD 54 so that the analog image-pixel signals are read from the CCD 54 at regular time intervals. Herein, the NTSC or PAL standard is applied; therefore, one field's-worth of image-pixel signals are read from the CCD 13 successively at 1/60- or 1/50-second time intervals. In accordance with the method of pixel mixture reading, odd-field image-pixel signals and even-field image-pixel signals are read from the CCD 54 alternately. The image-pixel signals are then fed to an initial signal-processing circuit 57 via an amplifier 55. In the initial signal-processing circuit 57, a given process is performed on the image-pixel signals. The processed analog image-pixel signals are fed from the initial signal-processing circuit 57 to a latter signal-processing circuit 28 in the video-processor 10.

In the latter signal-processing circuit 28, various processes, including a white-balance process and a gamma-correction process, are performed on the image-pixel signals, so that R, G, and B video signals are generated. The video signals are directly output to the monitor 9. Thus, a full-color moving image is displayed on the monitor 70.

When freeze button 53, provided on the video-scope 50, is operated to carry out a freeze operation, one frame's worth of image-pixel signals, which are obtained in a single exposure, are read from the CCD 54 in two interlaced fields.

The one frame's worth of image-pixel signals are sent to the latter signal processing circuit 28 via the amplifier 55 and the initial signal-processing circuit 57. In the latter signal-processing circuit 28, still image signals are generated for displaying a full-color still image on the monitor 70. Further more, as described later, the digitized image-pixel signals are transmitted to the recorder 60 via an I/F circuit 29, as still image data. Herein, image data is transmitted in accordance with the USB interface standard.

A system control circuit 22, including a CPU (not shown), controls the video-processor 10, and outputs control signals to circuits in the video-processor 10. A timing generator (not shown) in the video-processor 30 outputs clock pulse signals to adjust the timing of a signal process. A scope controller 56 in the video-scope 10 controls the video-scope 50, and outputs control signals to the initial signal-processing circuit 57 and to a timing generator 58. When the video-scope 50 is connected to the video-processor 10, data is transmitted between the scope controller 56 and the system control circuit 22. When the freeze button 53 is operated, the system control circuit 22 in the video-processor 10 outputs a control signal to the scope controller 56, and the scope controller 56 outputs control signals to the CCD driver 59 to change the signal reading method.

The rotary shutter 15, provided between the lamp 12 and the collective lens 16, rotates by driver signals output from a rotary shutter driver 23. A pivotable chopper 17 is provided between the rotary shutter 15 and the collective lens 16, and moves based on driver signals sent by a chopper driver 24.

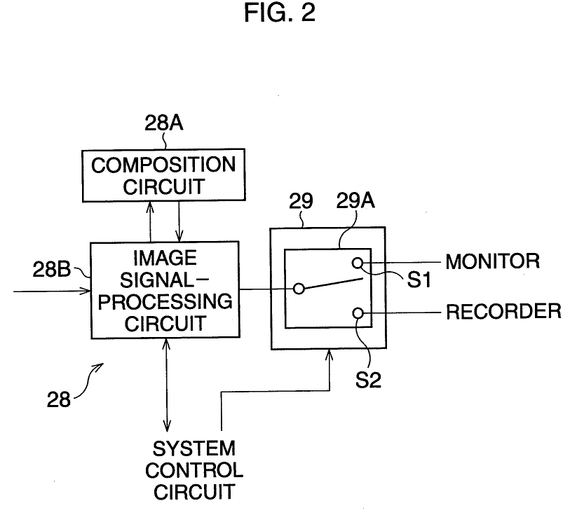

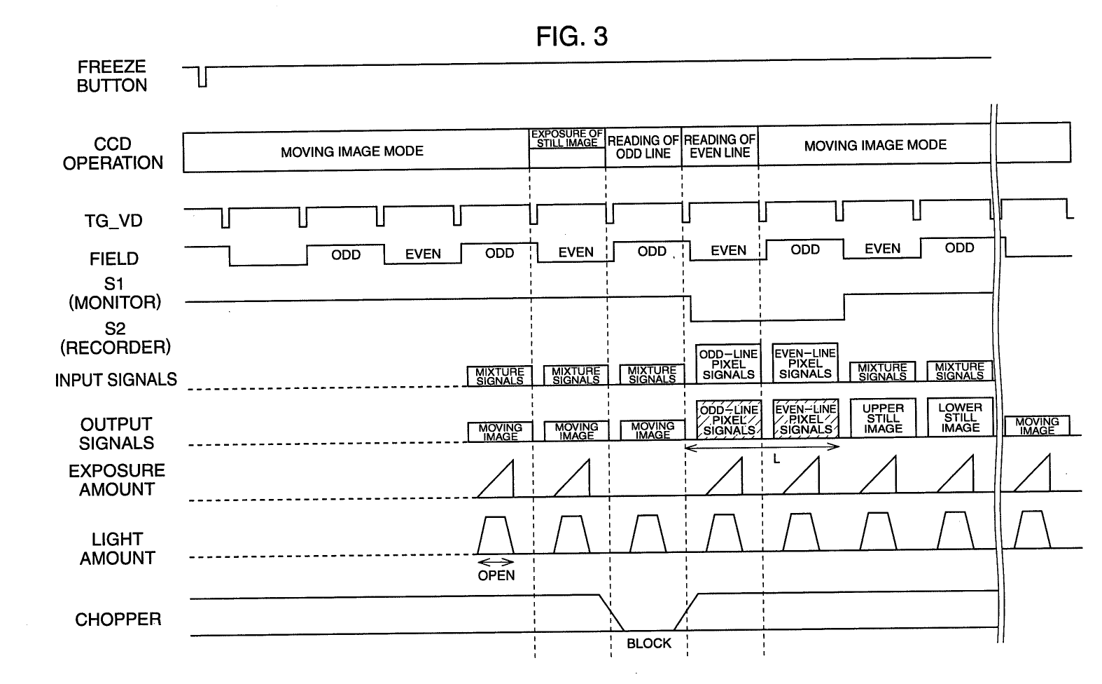

FIG. 2 is a block diagram of the latter signal-processing circuit 28 and the I/F circuit 29. FIG. 3 is a timing chart of the freeze operation.

As shown in FIG. 2, the latter signal-processing circuit 28 has a composition circuit 28A and an image signal-processing circuit 28B. The image signal-processing circuit 28B has a frame memory for temporarily storing image data. During the normal observation mode, the rotary shutter 15, which has an aperture portion and a shading portion, rotates at a constant speed with an angular period of 1/60 (or 1/50) second. Thus, the illuminating light from the lamp 12 is periodically shaded or blocked, and the exposure time is defined by the unshaded interval. In the image signal-processing circuit 28B, video signals are generated on the basis of the odd-field image-pixel signals and even-field image-pixel signals, and output to the I/F circuit 29. The I/F circuit 29 has a switch 29A, which connects a point or contact S1 with the image signal processing circuit 28B during the normal observation mode. Thus, the video signals are output to the monitor 70.

In the case of the freeze operation, a signal process for obtaining a still image is carried out. After one frame of image-pixel signals are generated in one field interval, first, odd-line image-pixel signals are read from the CCD 54 in the odd-field interval, and then even-line image-pixel signals are read from the CCD 54 in the even-field interval. The chopper 17 moves so as to shade the illuminating light over the odd-field interval (see FIG. 3).

The odd- and even-line image-pixel signals are sent to the composition circuit 28A in order. In the composition circuit 28A, first, even-line and odd-line image-pixel signals in the upper area of one frame are generated, and subsequently even-line and odd-line image-pixel signals in the lower area are synthesized.

In the case of the freeze operation, odd-line image-pixel signals and even-line image-pixel signals are read separately from the CCD 54, without the mixing of neighboring pixels. Consequently, each pixel lacks a full complement of the primary color information. However, color information for a given color element may be recovered from the color information of the neighboring pixels. In the composition circuit 28A, the process for interpolating color information is carried out on the basis of the separately-read odd- and even-line image-pixel signals.

The interpolation process is started after the odd- and even-line image-pixel signals are input to the composite circuit 28A. Therefore, two field intervals L are necessary for starting the interpolation process. Image signals in the upper area are generated in the odd-field interval of the two field intervals L, and image signals in the lower area are generated in the next even field interval. After the two field intervals L have passed, during the even-field interval, the image signals in the upper area are first output from the composite circuit 28A to the I/F circuit 29 via the image signal-processing circuit 28B. Then, in the odd-field interval, the image signals in the lower area are output to the I/F circuit 29 (see FIG. 3).

During the two field intervals L, the switch 29A is switched by a control signal from the system control circuit 31 such that the image signal-processing circuit 28B connects with a contact S2. Thus, the odd- and even-line image-pixel signals, fed from the video-scope 10, are directly output to the I/F circuit 29 over the two field intervals L (see FIG. 3). Thus, the odd- and even-line image-pixel signals are output to the recorder 60 as RAW data. In the recorder 60, one frame's worth of image data is recorded.

After the two field intervals L passed, the switch 29A is switched such that the image signal processing circuit 28B connects with the contact S1. Consequently, still image signals in the upper area and still image signals in the lower area are output to the monitor 70 over two field intervals. Further, the still image signals are temporarily stored in the frame memory in the image signal-processing circuit 28B so that one still image is displayed for a given period.

After the odd- and even-line image-pixel signals are read from the CCD 54, image-pixel signals are read from the CCD 54 in accordance to the method of the pixel mixing. Thus, the moving image is re-displayed after the still image is recorded on the recorder 60 and is displayed on the monitor 70.

Thus, in the present embodiment, while displaying a moving image, odd-field image-pixel signals and even-field image-pixel signals are alternately read from the CCD 54 in accordance with the pixel mixing method. When the freeze button 53 is operated, one frame of image-pixel signals obtained in a single exposure are divided into odd-line image-pixel signals and even-line image-pixel signals, which are read from the CCD 54 in order. Based on the odd- and even-line image-pixel signals, signal processes such as color interpolation are carried out in the composite circuit 28A, so that still image signals for displaying a still image are generated. Then, during the two field intervals L in which the still image signals are generated, the switch 29A changes the connection such that the image signal-processing circuit 28B connects with the recorder 60. Consequently, the odd- and even-line image pixel signals are sent to the recorder 60 via the I/F circuit 29 as RAW data. Since still image data is transmitted to the recorder 60 while the still image signals are generated, the display process and transmitting process of the still image data can be carried out rapidly, and the normal observation mode for displaying a moving image can be restored instantly. Also, the RAW data and the still image signals can be selectively output by the simple switch 29A in the I/F circuit 29.

An optional apparatus capable of recording image data may be connected to the video-processor 30 in place of the recorder 60. Also, image data may be transmitted by an interface standard other than the USB standard. As for the method of reading the image-pixel signal, other methods, besides the one described above, may be applied. In this case, the signal reading method may be selected in accordance with the charge transfer method of the CCD, the choice of color elements on the color filter, the imaging method, etc. The composition circuit 28A carries out a signal process in accordance with the method selected.

The switch 29A may be constructed of a semiconductor switch control chip. Further, the period over which the RAW data is output to the recorder 60 may be set to intervals longer than the two field intervals L.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2006-292246 (filed on Oct. 27, 2006), which is expressly incorporated herein, by reference, in its entirety.

1. An electronic endoscope comprising:
a first signal-reading processor that successively reads image-pixel signals, obtained by light passing through a color filter, from an image sensor at regular intervals;
a moving-image signal processor that generates video signals on the basis of the successively read image-pixel signals;
a second signal-reading processor that reads one frame's worth of image-pixel signals, obtained in a single exposure, from said image sensor;
a still-image signal processor that generates still image signals on the basis of the one frame's worth of image-pixel signals obtained in the single exposure; and
a signal output processor that is capable of outputting the video signals and the still image signals to peripheral equipment,
wherein said signal output processor outputs the one frame's worth of image-pixel signals obtained in the single exposure to said peripheral equipment while the still image signals are generated.

2. The electronic endoscope of claim 1, wherein said still-image signal processor comprises:
a first signal processor that connects with said signal output processor, and that receives the one-frame's worth of image-pixel signals; and
a second signal processor that connects with said first signal processor, and that generates the still image signals on the basis of the one frame's worth of image-pixel signals fed from said first signal processor.

3. The electronic endoscope of claim 1, wherein said signal output processor comprises a switch that selectively connects said still image signal processor to one of a monitor and a recording apparatus that is capable of recording a still image, said switch connecting said still-image signal processor with said recording apparatus.

4. The electronic endoscope of claim 1, further comprising an image switch member that is operated to display and/or record a still image, said second signal-reading processor being engaged when said image switch member is operated.

5. The electronic endoscope of claim 1, wherein color elements of said color filter are arrayed in a checkered pattern, and said image sensor is an inter-line transfer image sensor.

6. The electronic endoscope of claim 1, wherein said first signal-reading processor reads even-field image-pixel signals and odd-field image-pixel signals alternately while mixing neighboring pixels.

7. The electronic endoscope of claim 1, wherein said second-signal reading processor reads odd-line image-pixel signals and even-line image-pixel signals, obtained in a single exposure, in order.

8. The electronic endoscope of claim 6, wherein said still-image signal processor comprises a composite processor that interpolates color information on the basis of neighboring odd-line and even-line image-pixel signals.

9. An apparatus for processing image signals obtained by an electronic endoscope, comprising:
a signal reading processor that reads one frame's worth of image-pixel signals, obtained in a single exposure, from an image sensor;
a still-image signal processor that generates still image signals on the basis of the one frame's worth of image-pixel signals obtained in the single exposure; and
a signal output processor that is capable of outputting the still image signals to peripheral equipment,
wherein said signal output processor outputs the one frame's worth of image-pixel signals obtained in the single exposure to said peripheral equipment while the still image signals are generated.

10. A method for processing image signals obtained by an electronic endoscope, comprising:
reading one frame's worth of image-pixel signals, obtained in a single exposure, from an image sensor with a color filter that is provided in a video-scope;
generating still image signals on the basis of the one frame's worth of image-pixel signals obtained in the single exposure; and
outputting the one frame's worth of image-pixel signals obtained in the single exposure to peripheral equipment while the still image signals are generated.
